(19) United States
(12) Patent Application Publication
(10) Pub. No.: US 2022/0058603 A1
(43) Pub. Date: Feb. 24, 2022

(54) COMMODITY REGISTRATION DEVICE AND CONTROL PROGRAM FOR COMMODITY REGISTRATION DEVICE

(71) Applicant: TOSHIBA TEC KABUSHIKI KAISHA, Tokyo (JP)

(72) Inventor: Tsuyoshi GOTANDA, Ota Tokyo (JP)

(73) Assignee: TOSHIBA TEC KABUSHIKI KAISHA, Tokyo (JP)

(21) Appl. No.: 17/338,077

(22) Filed: Jun. 3, 2021

(30) Foreign Application Priority Data
Aug. 24, 2020 (JP) 2020-141131

(51) Int. Cl. G06Q 20/18

(52) U.S. Cl. CPC G06Q 20/18

(57) ABSTRACT

A commodity registration device includes an input device, a processor, and a controller. The input device inputs information about a commodity. The processor registers sales data of the commodity, based on the information inputted. The controller controls the input device according to an image captured by a camera of an area where the commodity is placed.

### CROSS-REFERENCE TO RELATED APPLICATION

This application is based upon and claims the benefit of priority from Japanese Patent Application No. 2020-141131, filed on Aug. 24, 2020, the entire contents of which are incorporated herein by reference.

### FIELD

Embodiments described herein relate generally to a commodity registration device and a control program for a commodity registration device.

### BACKGROUND

A commodity registration device may be a self-service POS (point of sales) terminal that enables a customer to carry out processing from registration to settlement for a purchased commodity by the customer himself or herself. Most of related-art self-service POS terminals have an integrated weight scale. This type of self-service POS terminal uses a data file that stores unit weight data on a per commodity basis, that is, a so-called weight master. A customer operates a scanner or a touch panel to input data of a commodity to be purchased and places the commodity whose data has been inputted, on the weight scale. The self-service POS terminal collates actual weight data of the commodity weighed on the weight scale with unit weight data of the commodity whose data has been inputted, and permits the next data input if there is no problem. Such a mechanism prevents fraud such as wrongfully replacing a commodity whose data has been inputted with a different commodity and putting the different commodity on the weight scale, and also prevents the barcode of the same commodity from being doubly read by the scanner.

### DESCRIPTION OF THE DRAWINGS

FIG. 1 is a configuration view showing an example of a checkout system formed at a store where a self-service POS terminal is introduced.

FIG. 2 is an explanatory view for explaining an example of the arrangement of the self-service POS terminal.

FIG. 3 is a block diagram showing the circuit configuration of an essential part of the self-service POS terminal.

FIG. 4 is a flowchart showing procedures of main information processing executed by a processor according to a control program.

FIG. 5 is a flowchart showing procedures of the main information processing.

FIG. 6 is a block diagram showing the circuit configuration of an essential part of a self-service POS terminal according to at least one embodiment.

FIG. 7 is a flowchart showing essential procedures of main information processing executed by a processor according to a control program in at least one embodiment.

### DETAILED DESCRIPTION

In a system as described above, the self-service POS terminal with the integrated weight scale needs a weight master and therefore has a problem in that it takes time and effort to generate a weight master. Thus, recently, a simple self-service POS terminal that needs no weight master has been developed and put into practical use at relatively small-scale stores such as convenience stores and kiosks. However, the simple self-service POS terminal does not have the function of preventing fraud of wrongfully replacing a commodity and does not have the function of preventing the double reading of the barcode, either.

At least one embodiment described herein is to provide a commodity registration device of a simple type that needs no weight master but has the function of preventing the fraud of wrongfully replacing a commodity and the function of preventing double reading of the barcode or the like.

In general, according to at least one embodiment, a commodity registration device includes an input unit (e.g., an input device), a processing unit (e.g., a processor), and a control unit (e.g., a controller). The input unit inputs information about a commodity. The processing unit registers sales data of the commodity, based on the information inputted from the input unit. The control unit controls the input unit according to an image captured by a camera of an area where the commodity is put (e.g., placed, located).

At least one embodiment of a commodity registration device will now be described with reference to the drawings.

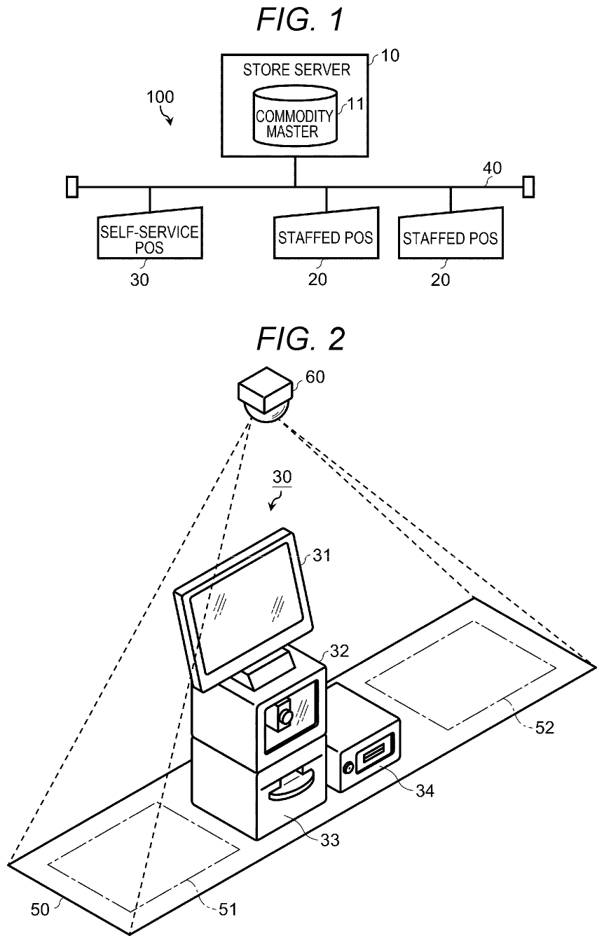

In at least one embodiment, a simple self-service POS terminal 30 (see FIG. 1) having no weight master is described as an example of the commodity registration device.

### First Embodiment

FIG. 1 is a configuration view showing an example of a checkout system 100 formed at a store where the self-service POS terminal 30 is introduced. The checkout system 100 includes a store server 10, a staffed POS terminal 20, the self-service POS terminal 30, and a network 40. The network 40 is laid inside the store. The network 40 is, for example, a LAN (local area network). In the checkout system 100, the store server 10, two staffed POS terminals 20, and the self-service POS terminal 30 are connected to the network 40.

The store server 10 has a commodity master 11. The commodity master 11 is an aggregate of commodity records generated on a per commodity basis about commodities sold at the store. A commodity record is formed of data items that are necessary for sales registration of a commodity, such as a commodity code, a commodity name, and a unit price. The staffed POS terminal 20 or the self-service POS terminal 30 accepts a commodity code unique to a commodity to be purchased by a customer, as data of the commodity. When the commodity code is inputted, the staffed POS terminal 20 or the self-service POS terminal 30 registers sale data such as the number of items sold, the unit price, and the amount of sales of the commodity, based on the data of the commodity record including the commodity code.

The staffed POS terminal 20 is a commodity registration device for a sales clerk to carry out processing from registration to settlement for a commodity purchased by a customer. The staffed POS terminal 20 is a known device and therefore will not be described further in detail. The self-service POS terminal 30 is a commodity registration device that enables a customer to carry out processing from registration to settlement for a purchased commodity by the customer himself or herself. The self-service POS terminal 30 is a simple self-service POS terminal that needs no weight master. While FIG. 1 shows two staffed POS terminals 20 and one self-service POS terminal 30, any number of these terminals may be employed. The number of terminals is suitably decided, based on the scale of the store, the demographics of customers, and the like.

FIG. 2 is an explanatory view for explaining an example of the arrangement of the self-service POS terminal 30. The self-service POS terminal 30 is formed of a suitable combination of input and output devices such as a touch panel 31, a scanner 32, a printer 33, and a card reader 34, and is arranged substantially at the center of a counter 50. A top surface of the counter 50 on the left as viewed from the front of the self-service POS terminal 30 is defined as a placement area 51 for unregistered commodity. A top surface of the counter 50 on the right is defined as a placement area 52 for registered commodity. The front of the self-service POS terminal 30 in at least one embodiment is the near side where a screen of the touch panel 31, a reading window of the scanner 32, a receipt dispensing port of the printer 33, and a card insertion port of the card reader 34 are arranged.

The left and right positions of the placement areas 51 and 52 may be reversed. The placement areas 51 and 52 may be not directly to the right and left of the self-service POS terminal 30 but may be shifted to the front or to the rear.

The touch panel 31 functions both as an input device that accepts a touch operation and as an output device based on a screen display. The touch panel 31 displays an image of a list of, for example, commodities with no barcode attached such as vegetables and fruit. A customer who purchases a commodity with no barcode attached selects the purchased commodity from the image of the list and makes a touch operation.

The scanner 32 is an input device for scanning a barcode or a two-dimensional code and reading its code data. Many commodities have a barcode attached indicating a commodity code unique to each commodity. The scanner 32 can read the barcode. The scanner 32 can also read a barcode or a two-dimensional code for code settlement.

The printer 33 is an output device for printing and outputting receipt data showing details of a transaction on a predetermined receipt paper. The receipt paper with the receipt data printed is cut by a cutter and dispensed as a paper receipt.

The card reader 34 is an input device for reading data recorded on a card medium such as a credit card, an electronic money card, or a loyalty card. The card reader 34 is typically an IC card reader. The card reader 34 may be, for example, a magnetic card reader.

The combination of the input and output devices is not limited to the touch panel 31, the scanner 32, the printer 33, and the card reader 34. For example, a compact keyboard including ten keys may be added. Alternatively, employing an electronic receipt system enables the omission of the printer 33.

Above the counter 50, a surveillance camera 60 is installed. The surveillance camera 60 covers, as its capture area, substantially the entire area of the counter 50 ranging from the placement area 51 for unregistered commodity to the placement area 52 for registered commodity. Therefore, an action of a customer placing a commodity in the placement area 51, an action of the customer picking up the commodity from the placement area 51 and moving the commodity to the placement area 52, an action of the customer placing the commodity in the placement area 52, and the like, can be recognized from images captured by the surveillance camera 60. The surveillance camera 60 is a two-dimensional camera. The surveillance camera 60 may be a three-dimensional camera such as a stereo camera or a ToF (time-of-flight) camera.

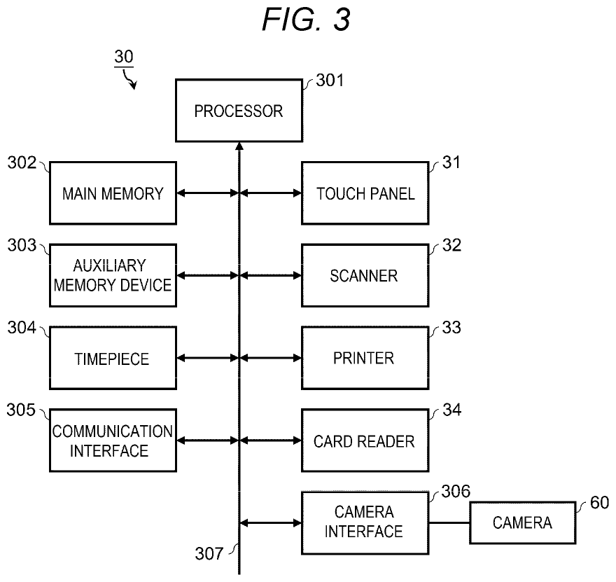

FIG. 3 is a block diagram showing the circuit configuration of an essential part of the self-service POS terminal 30. The self-service POS terminal 30 has a processor 301, a main memory 302, an auxiliary memory device 303, a timepiece 304, a communication interface 305, the touch panel 31, the scanner 32, the printer 33, the card reader 34, and a camera interface 306. In the self-service POS terminal 30, the processor 301, the main memory 302, the auxiliary memory device 303, the timepiece 304, the communication interface 305, the touch panel 31, the scanner 32, the printer 33, the card reader 34, and the camera interface 306 are connected together via a system bus 307. The system bus 307 includes an address bus, a data bus, and the like.

In the self-service POS terminal 30, the processor 301 is connected to the main memory 302, the auxiliary memory device 303, the timepiece 304, the communication interface 305, and the camera interface 306 via the system bus 307 and thus forms a computer. The computer is integrated with the touch panel 31.

The computer may not necessarily be integrated with the touch panel 31. The computer may be a separate desktop PC and various input and output devices may be connected to the desktop PC via a wire or wirelessly, so as to form the self-service POS terminal 30.

The processor 301 is equivalent to a central unit of the computer. The processor 301 controls each part in order to implement various functions of the self-service POS terminal 30 according to an operating system or an application program. The processor 301 is, for example, a CPU (central processing unit).

The main memory 302 is equivalent to a main memory part of the computer. The main memory 302 includes a non-volatile memory area and a volatile memory area. The main memory 302 stores an operating system and an application program in the non-volatile memory area. The main memory 302 stores, in the volatile memory area, data that is necessary for the processor 301 to execute processing to control each part. The volatile memory area in the main memory 302 is also used as a work area by the processor 301 to rewrite data according to need. The non-volatile memory area is, for example, a ROM (read-only memory). The volatile memory area is, for example a RAM (random-access memory).

The auxiliary memory device 303 is equivalent to an auxiliary memory part of the computer. As the auxiliary memory device 303, for example, a known memory device such as an EEPROM (electrically erasable programmable read-only memory), an HDD (hard disk drive), or an SSD (solid-state drive) may be used by itself, or a combination of a plurality of such memories may be used. In the auxiliary memory device 303, data used by the processor 301 to perform various kinds of processing, data generated by the processing by the processor 301, or the like, are saved. The auxiliary memory device 303 may store an application program.

The application program stored in the main memory 302 or the auxiliary memory device 303 includes a control program, described later. The installation of the control program in the main memory 302 or the auxiliary memory device 303 is not limited to any particular method. The control program can be recorded in a removable recording medium or distributed by communication via a network and then installed in the main memory 302 or the auxiliary memory device 303. The recording medium may be in any form, provided that the recording medium can record a program and is readable by the device, such as a CD-ROM or a memory card.

The timepiece 304 functions as a time information source of the self-service POS terminal 30. The processor 301 tracks the current date and time, based on time information tracked by the timepiece 304.

The communication interface 305 is a circuit for data communication with the store server 10 connected via the network 40 in conformity with a predetermined communication protocol.

The camera interface 306 is an interface having a function of activating the surveillance camera 60 and taking in an actual image captured by the surveillance camera 60.

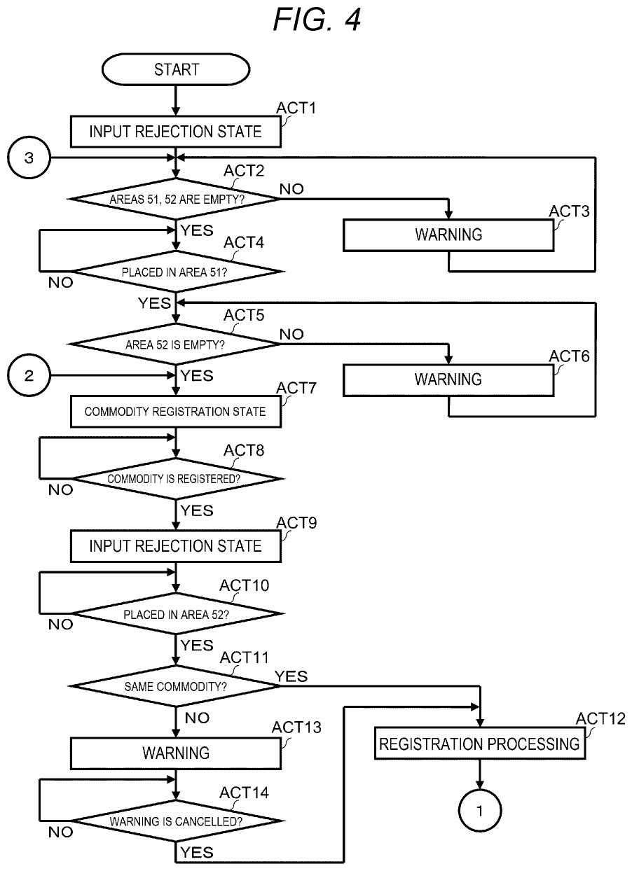

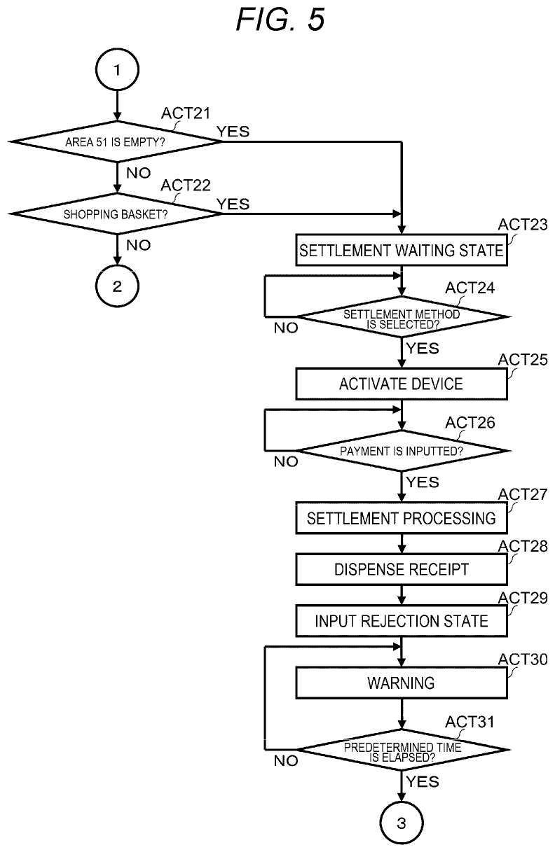

FIGS. 4 and 5 are flowcharts showing procedures of main information processing executed by the processor 301 according to the control program. Main operations of the self-service POS terminal 30 will now be described with reference to FIGS. 4 and 5. The operations described below are simply an example. The procedures can be suitably changed, provided that similar effects are achieved.

First, in ACT 1, the processor 301 sets the operation state of the self-service POS terminal 30 to an input rejection state. The input rejection state is a state where an input is not accepted from the touch panel 31, the scanner 32, and the card reader 34, which are input devices. The input rejection state may be a state where, even if an input is made, this input is disabled or the inputted data is read and discarded.

In the input rejection state, the processor 301 in ACT 2 analyzes an image from the surveillance camera 60 and checks whether the placement area 51 for unregistered commodity and the placement area 52 for registered commodity are free of any object or not. If an object is placed in at least one of the areas 51, 52, the processor 301 gives NO in ACT 2 and proceeds to ACT 3. In ACT 3, the processor 301 gives (emits) a warning. Subsequently, the processor 301 returns to ACT 2. That is, the processor 301 analyzes the image from the surveillance camera 60 and continues to give a warning until the object placed in the placement area 51 and the placement area 52 is removed.

In the placement area 51 or the placement area 52, an object such as a shopping basket provided at the store or a commodity left behind by a customer may be placed. In the self-service POS terminal 30 in the default state, the placement area 51 and the placement area 52 need to be empty. Therefore, in ACT 3, the processor 301 gives a sales clerk a warning that there is an object in the placement area 51 or the placement area 52. The warning is given, for example, to one of the staffed POS terminal 20 and the store server 10 or both. In response to this warning, a sales clerk who is the operator of the staffed POS terminal 20 or a sales clerk monitoring the state of the store server 10 removes the object placed in the placement area 51 or the placement area 52.

On confirming that the placement area 51 and the placement area 52 are both empty, the processor 301 gives YES in ACT 2 and proceeds to ACT 4. In ACT 4, the processor 301 analyzes the image from the surveillance camera 60 and waits for an object to be placed in the placement area 51.

A customer making a self-service settlement for a purchased commodity places an unregistered commodity in the placement area 51 of the available self-service POS terminal 30. At this point, the customer may put the unregistered commodity in a shopping basket and place the shopping basket with the registered commodity inside or may place the unregistered commodity without a shopping basket.

The surveillance camera 60 captures the action of the customer placing the purchased commodity in the placement area 51. This causes the processor 301 to recognize that an object is placed in the placement area 51. The processor 301 gives YES in ACT 4 and proceeds to ACT 5. In ACT 5, the processor 301 confirms that no object is placed in the placement area 52.

Although the placement area 51 and the placement area 52 are both empty in the default state, an object may be put in the placement area 52 while the processor 301 is waiting for an object to be placed in the placement area 51. If an object is put in the placement area 52, the processor 301 gives NO in ACT 5 and gives a warning in ACT 6. In this case, it is desired that this warning is given not only to the sales clerk as in the processing of ACT 3 but also to the customer who has put the purchased commodity in the placement area 51. For example, in at least one embodiment the processor 301 displays a guide having a content such as “Remove the object put on the right counter and then start registration of the commodity” on the touch panel 31. As a matter of course, the content of the guide is not limited to this.

After giving a warning in ACT 6, the processor 301 returns to ACT 5. That is, the processor 301 analyzes the image from the surveillance camera 60 and continues to give a warning until the object placed in the placement area 52 is removed.

On confirming that the placement area 52 is empty, the processor 301 gives YES in ACT 5 and proceeds to ACT 7. In ACT 7, the processor 301 sets the operation state of the self-service POS terminal 30 to a commodity registration state. The commodity registration state is a state where an input is accepted from the touch panel 31 or the scanner 32, which are commodity code input devices. At this point, the processor 301 displays a guide having a content such as “Register the commodity” on the touch panel 31 or by causing an LED lamp, not illustrated, to emit light in a predetermined color, and thus notifies the customer that the registration of the purchased commodity is available.

Upon confirming that the operation state of the self-service POS terminal 30 has turned into the commodity registration state, the customer picks up one item of the purchased commodity from the placement area 51. In the description below, the commodity item picked up from the placement area 51 is referred to as a registration target commodity.

If the registration target commodity has a barcode attached, the customer holds the barcode up to the reading window of the scanner 32. If the registration target commodity has no barcode attached, the customer operates the touch panel 31 to select the registration target commodity from an image of a list of commodities with no barcode.

In ACT 8, the processor 301, now in the commodity registration state, waits for the commodity to be registered. The processor 301 determines that the commodity is registered, if the barcode attached to the commodity is scanned by the scanner 32 or if a commodity is selected from the image of the list of commodities with no barcode, displayed on the touch panel 31. The processor 301 gives YES in ACT 8 and proceeds to ACT 9. In ACT 9, the processor 301 sets the operation state of the self-service POS terminal 30 to the input rejection state. In ACT 10, the processor 301 analyzes the image from the surveillance camera 60 and waits for an object to be placed in the placement area 52. The customer puts the registration target commodity whose barcode has already been scanned or the registration target commodity that has already been selected from the image of the list of commodities with no barcode, in the placement area 52.

The surveillance camera 60 captures an image of the action of the customer placing the registration target commodity in the placement area 52. This causes the processor 301 to recognize that an object is placed in the placement area 52. The processor 301 gives YES in ACT 10 and proceeds to ACT 11. In ACT 11, the processor 301 analyzes the image from the surveillance camera 60 and determines whether the same commodity is moved from the placement area 51 to the placement area 52 or not.

Specifically, the processor 301 compares an image of the placement area 51 before the registration of the commodity with an image of the placement area 51 after the registration of the commodity and recognizes the shape of the object picked up from the placement area 51. Similarly, the processor 301 compares an image of the placement area 52 before the object is placed in the placement area 52 with an image of the placement area 52 after the object is placed in the placement area 52 and recognizes the shape of the object placed in the placement area 52. If the coincidence of the two shapes is confirmed, the processor 301 determines that the same commodity is moved from the placement area 51 to the placement area 52. If the coincidence of the two shapes is not confirmed, the processor 301 determines that the same commodity is not moved from the placement area 51 to the placement area 52.

If it is determined that the same commodity is moved from the placement area 51 to the placement area 52, the processor 301 gives YES in ACT 11 and proceeds to ACT 12. In ACT 12, the processor 301 executes registration processing. That is, the processor 301 acquires the commodity code from the scanned barcode. Alternatively, the processor 301 acquires the commodity code of the commodity selected from the image of the list of commodities with no barcode. The processor 301 then registers sales data of this commodity, based on the data of the commodity record including this commodity code.

Meanwhile, if it is determined that the same commodity is not moved from the placement area 51 to the placement area 52, the processor 301 gives NO in ACT 11 and proceeds to ACT 13. In ACT 13, the processor 301 gives a warning. For example, if the customer puts, in the placement area 52, a commodity that is different from the commodity picked up from the placement area 51, it is determined that the same commodity is not moved from the placement area 51 to the placement area 52. Thus, the processor 301 gives a warning to a sales clerk, as in ACT 3. On confirming the warning, the sale clerk goes to the place where the self-service POS terminal 30 is installed, and checks whether there is any fraud or not. If there is no fraud, for example, the sales clerk operates the touch panel 31 to cancel the warning. If there is fraud, the sales clerk does not cancel the warning because the fraud needs to be dealt with.

After giving the warning, the processor 301 in ACT 14 waits for the warning to be canceled. If the warning is canceled, the processor 301 gives YES in ACT 14 and proceeds to ACT 12. That is, in ACT 12, the processor 301 executes registration processing.

On finishing the registration processing, the processor 301 in ACT 21 in FIG. 5 analyzes the image from the surveillance camera 60 and checks whether the object placed in the placement area 51 is gone or not. If the object is not gone, the processor 301 gives NO in ACT 21 and proceeds to ACT 22. In ACT 22, the processor 301 analyzes the image further and checks whether the object placed in the placement area 51 is an empty shopping basket or not. Such checking can be carried out, based on a matching between image data of an empty shopping basket captured from various angles and image data captured by the surveillance camera 60.

If the object placed in the placement area 51 is not an empty shopping basket, the processor 301 gives NO in ACT 22 and returns to ACT 7 in FIG. 4. That is, the processor 301 sets the operation state of the self-service POS terminal 30 to the commodity registration state and executes the processing from ACT 8 onward, as described above.

If the registration processing on the purchased commodity is not finished, an unregistered purchased commodity is left in the placement area 51. In this case, the processor 301 waits until the processing of ACT 12, that is, the registration processing on the registration target commodity placed in the placement area 52, is finished, and then the processor 301 changes the operation state of the self-service POS terminal 30 from the input rejection state to the commodity registration state. In other words, the operation state of the self-service POS terminal 30 is the input rejection state until the registration processing on the registration target commodity is finished. Therefore, the scanner 32 will not doubly read the barcode of the registration target commodity.

On completion of the registration processing on the purchased commodity, no object is placed in the placement area 51 or only an empty shopping basket is placed in the placement area 51. In this case, the processor 301 gives YES in ACT 21 or ACT 22 and proceeds to ACT 23. In ACT 23, the processor 301 set the operation state of the self-service POS terminal 30 to a settlement waiting state. The settlement waiting state is a state where a selection of a settlement method is accepted. A typical settlement method employed at the self-service POS terminal 30 is a cashless settlement method, such as electronic money settlement, code settlement, or credit card settlement. The processor 301 displays, on the touch panel 31, a settlement method selection screen to allow a selection of one of these settlement methods, and thus prompts the customer to select a settlement method. On confirming the settlement method selection screen, the customer touches the screen to select a desired settlement method. At this point, if it is detected from the image from the surveillance camera 60 that an empty shopping basket is left in the placement area 51, it is desired that the processor 301 displays a guide having a content such as “Return the shopping basket to the basket storage place” on the touch panel 31 and thus notifies the customer that the shopping basket should not be left behind.

After setting the operation state of the self-service POS terminal 30 to the settlement waiting state in ACT 23, the processor 301 proceeds to ACT 24. In ACT 24, the processor 301 waits for one of these settlement methods to be selected. On detecting that one of these settlement methods is selected, based on a signal from the touch panel 31, the processor 301 gives YES in ACT 24 and proceeds to ACT 25. In ACT 25, the processor 301 activates a device corresponding to the selected settlement method. That is, if electronic money settlement or credit card settlement is selected, the processor 301 activates the card reader 34. If code settlement is selected, the processor 301 activates the scanner 32.

After activating the device, the processor 301 in ACT 26 waits for payment data to be inputted via this device. That is, if electronic money settlement is selected, the processor 301 waits for the balance data of an electronic money card to be inputted via the card reader 34. If credit card settlement is selected, the processor 301 waits for the data of a credit card to be inputted via the card reader 34. If code settlement is selected, the processor 301 waits for the data of a barcode or a two-dimensional code for code settlement to be scanned by the scanner 32.

If payment data is inputted, the processor 301 gives YES in ACT 26 and proceeds to ACT 27. In ACT 27, the processor 301 executes settlement processing. That is, if the payment data is the balance data of an electronic money card, the processor 301 executes processing of subtracting the amount of transaction of the purchased commodity from the balance data. If the payment data is the data of a credit card, the processor 301 executes processing of authenticating the credit card. If the payment data is the data of a barcode or a two-dimensional code for code settlement, the processor 301 executes processing of subtracting the amount of transaction from the amount based on the data. Such settlement processing is known and therefore will not be described further in detail.

In at least one embodiment, three types of settlement methods, that is, electronic money settlement, credit card settlement, and code settlement, are described. However, the available settlement method is not limited to these. Any two of these types of settlement methods may be employed. Alternatively, another settlement method, for example, settlement by loyalty points or the like may be added. Also, the available settlement method may be limited to one of these types. If only one type of settlement method is available, the processor 301 does not execute the processing of ACT 24.

On finishing the settlement processing, the processor 301 proceeds to ACT 28. In ACT 28, the processor 301 causes the printer 33 to operate and controls the dispensation of a receipt. In ACT 29, the processor 301 sets the operation state of the self-service POS terminal 30 to the input rejection state. Then, in ACT 30, the processor 301 gives a warning. This warning is given to the customer who has used the self-service POS terminal 30. For example, the processor 301 displays a guide having a content such as “Take your purchased commodity away. Do not forget to take the receipt” on the touch panel 31 and thus notifies the customer so that the customer will not forget to take the commodity and the receipt.

In ACT 31, the processor 301 checks whether a predetermined time (e.g. a threshold time), for example, 10 seconds, is elapsed from the start of the warning or not. If the predetermined time is not elapsed, the processor 301 continues the warning.

If the predetermined time is elapsed from the start of the warning, the processor 301 gives YES in ACT 31 and returns to ACT 2 in FIG. 4. That is, the processor 301 analyzes the image from the surveillance camera 60 and checks whether the placement area 51 for unregistered commodity and the placement area 52 for registered commodity are free of any object or not. If, for example, a commodity is left behind in the placement area 52, the processor 301 proceeds to ACT 3 and gives a warning. Incidentally, the printer 33 is provided with a sensor for detecting that the customer has forgot to take the receipt. It is desired that if it is detected by this sensor that the customer has forgot to take the receipt, similarly, the processor 301 proceeds to ACT 3 and gives a warning.

As described above, the self-service POS terminal 30 has the touch panel 31 and the scanner 32 as an input unit (e.g., an input device) inputting information about a commodity. In the self-service POS terminal 30, the processor 301 is configured to execute the processing of ACT 12 as a processing unit (e.g., a processor) performing registration processing on sales data of a commodity, based on information inputted from the input unit. Also, in the self-service POS terminal 30, the processor 301 is configured to execute the processing of ACT 1, ACT 7, ACT 9, and ACT 23 as a control unit (e.g., a controller) controlling the input unit according to an image captured by the surveillance camera 60 of an area where the commodity is put.

Specifically, the area includes the placement area 52 as a first area where a commodity whose information is already inputted by the input unit is put. If the information is inputted by the input unit, the processor 301 sets the input unit to the input rejection state in ACT 9. If it is detected from the image that a commodity is put in the placement area 52, the processor 301 cancels the input rejection state in ACT 7 or ACT 23. That is, the processor 301 sets the operation state of the self-service POS terminal 30 to the commodity registration state or the settlement waiting state.

In this way, after the barcode of a commodity is read by the scanner 32, the self-service POS terminal 30 rejects the barcode reading by the scanner 32 until the commodity is put in the placement area 52. Thus, the self-service POS terminal 30 can implement the function of preventing double reading of the barcode.

The area also includes the placement area 51 as a second area where a commodity whose information is yet to be inputted by the input unit is put. The processor 301 sets the input unit to the input rejection state in ACT 1 until a commodity is put in the placement area 51. If it is detected from the image that a commodity is put in the placement area 51, the processor 301 cancels the input rejection state in ACT 7. That is, the processor 301 sets the operation state of the self-service POS terminal 30 to the commodity registration state.

In this way, in the self-service POS terminal 30, the input device such as the touch panel 31 or the scanner 32 does not accept any input until a customer puts a purchased commodity in the placement area 51. Thus, a malfunction of the self-service POS terminal 30 due to a fraudulent operation on the input device can be prevented.

If it is detected from the image that a commodity put in the placement area 51 is gone, the processor 301 sets the input unit to an input waiting state for settlement information in ACT 23 or ACT 25.

In this way, the settlement becomes available on condition that a commodity put in the placement area 51 is gone. Therefore, the customer can swiftly shift to the settlement. Also, the customer cannot make the settlement until registering purchased commodities put in the placement area 51, one by one, and moving all the purchased commodities after the registration to the placement area 52. This can make the customer keenly aware of the need to register a commodity picked up from the placement area 51, with the scanner 32 or the touch panel 31, and then move the commodity to the placement area 52. Such awareness is advantageous in restraining the customer from carrying out a fraudulent operation.

In the self-service POS terminal 30, the processor 301 is configured to execute the processing of ACT 11 as a determination unit determining whether the same commodity is moved from the placement area 51 to the placement area 52 or not. That is, the processor 301 determines whether a commodity having the same shape is moved from the placement area 51 to the placement area 52, based on the amount of change in a captured image of the placement area 51 and the amount of change in a captured image of the placement area 52. Then, on condition that it is determined that a commodity having the same shape is moved from the placement area 51 to the placement area 52, the processor 301 executes registration processing in ACT 12.

In this way, unless the customer puts a commodity picked up from the placement area 51 to the placement area 52, the self-service POS terminal 30 does not execute registration processing on the commodity. If the fraud of wrongfully replacing the commodity is conducted, a warning is given. Therefore, this type of fraud can be easily found out.

The surveillance camera 60 is installed above the self-service POS terminal 30. Therefore, the customer is aware of being monitored while operating the self-service POS terminal 30. This can also achieve the effect of restraining the customer from carrying out a fraudulent operation.

If it is detected from the image that a commodity is put in the placement area 52 after settlement processing is finished by the input of settlement information, the processor 301 gives a warning in ACT 3. This warning swiftly notifies a sales clerk if the customer has left a commodity in the placement area 52. Therefore, the sales clerk can easily take measures such as quickly finding the customer who has left the commodity, based on the image from the surveillance camera 60, and catching up with the customer.

Also, if it is detected from the image that a commodity is put in the placement area 52 when a commodity is put in the placement area 51, the processor 301 similarly gives a warning in ACT 3. Therefore, the next customer may notice that the previous customer has left the commodity, and may notify a sales clerk. The next customer can carry out self-service registration of a purchased commodity by removing the left-behind commodity from the placement area 52. Therefore, there is no problem with the operational efficiency of the self-service POS terminal 30.

### Second Embodiment

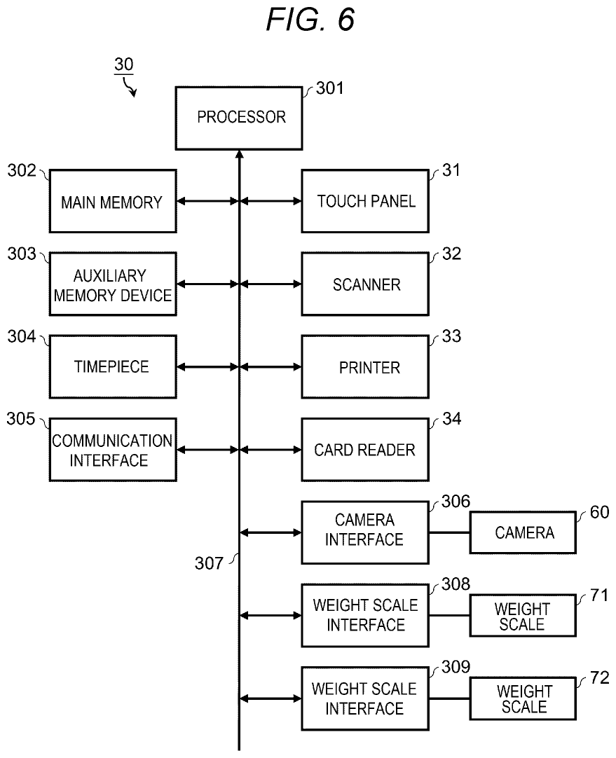

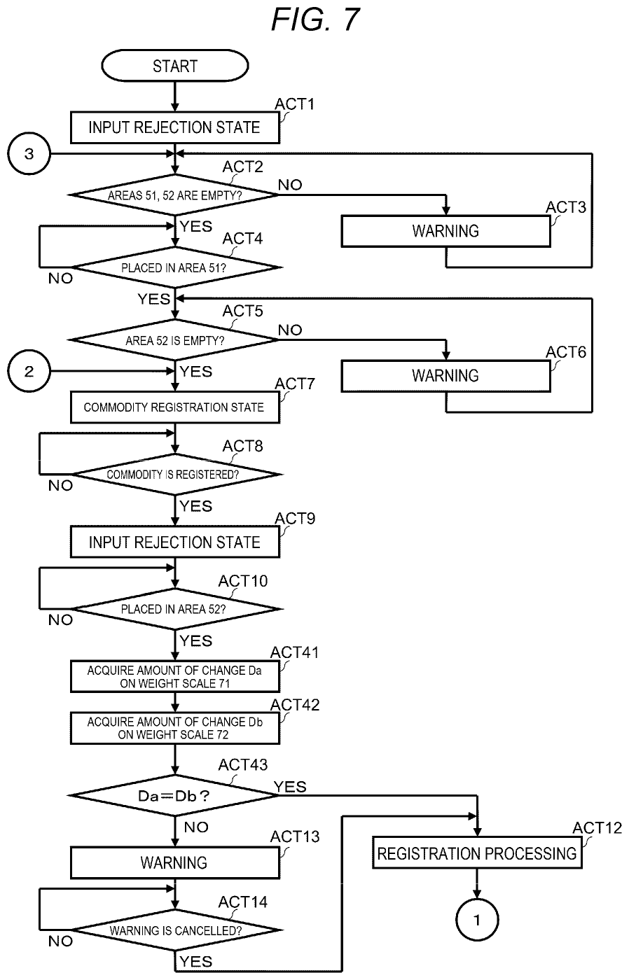

A second embodiment will now be described. In this embodiment, too, the self-service POS terminal 30 is employed as an example of the commodity registration device, as in the first embodiment. Therefore, FIGS. 1 and 2 are employed in the second embodiment as well. Meanwhile, FIG. 6 is a block diagram showing the circuit configuration of an essential part of the self-service POS terminal 30. FIG. 7 shows an essential part of main information processing executed by the processor 301. The same components as in the first embodiment are denoted by the same reference signs and are not described further in detail.

As shown in FIG. 6, the self-service POS terminal 30 in at least one embodiment (i.e., the second embodiment different from the first embodiment) two weight scale interfaces 308, 309 are connected to the system bus 307. One weight scale interface 308 takes in weight data measured by a weight scale 71, which is a first weight scale. The other weight scale interface 309 takes in weight data measured by a weight scale 72, which is a second weight scale.

The weight scale 71 measures the total weight of an object placed in the placement area 51 of the counter 50. The weight scale 72 measures the total weight of an object placed in the placement area 52 of the counter 50.

As shown in FIG. 7, in ACT 1 to ACT 10, the processor 301 performs information processing similar to that in the first embodiment. If the processor 301 recognizes in ACT 10 that an object is placed in the placement area 52, based on the image from the surveillance camera 60, the processor 301 in ACT 41 acquires an amount of change Da on the weight scale 71 that occurs when the registration target commodity is picked up from the placement area 51. Also, in ACT 42, the processor 301 acquires an amount of change Db on the weight scale 72 that occurs when the registration target commodity is placed in the placement area 52.

In ACT 43, the processor 301 checks whether the amount of change Da and the amount of change Db coincide with each other or not. If the commodity picked up from the placement area 51 is put in the placement area 52, the amount of change Da and the amount of change Db coincide with each other. If the amounts of change coincide with each other, the processor 301 gives YES in ACT 43 and proceeds to ACT 12. In ACT 12, the processor 301 executes registration processing. The processing from ACT 12 onward is the same as in the first embodiment.

If the amount of change Da and the amount of change Db do not coincide with each other, the processor 301 proceeds to ACT 13. In ACT 13, the processor 301 gives a warning. The processing from ACT 13 onward is the same as in the first embodiment.

In this way, in at least one embodiment, whether a commodity picked up from the placement area 51 is properly placed in the placement area 52 or not, that is, whether the fraud of wrongfully replacing a commodity is conducted or not, is checked, based on the amounts of change Da, Db on the weight scale 71 and the weight scale 72. Therefore, the second embodiment is advantageous in being able to reduce the processing load of the processor 301, compared with the first embodiment, where similar checking is carried out based on image analysis.

While the weight scales 71, 72 are needed in the second embodiment, unit weight data of a commodity is not needed. Therefore, a weight master is not needed.

The embodiments of the commodity registration device have been described. However, these embodiments are not limiting.

For example, in at least one embodiment, in ACT 11, the image from the surveillance camera 60 is analyzed to determine whether the same commodity is moved from the placement area 51 to the placement area 52 or not. In at least one embodiment, the determination processing of ACT 11 and the accompanying processing of ACT 13 and ACT 14 may be omitted. That is, if the processor 301 recognizes in ACT 10 that an object is placed in the placement area 52, the processor 301 may execute registration processing in ACT 12. In at least one embodiment, the processor 301 may execute registration processing before recognizing that an object is placed in the placement area 52.

Even if such configurations are employed, the function of preventing the double reading of the barcode can be securely implemented. Also, since the surveillance camera 60 is installed above the self-service POS terminal 30, the effect of restraining the customer from carrying out a fraudulent operation can be achieved.

For example, in at least one embodiment, whether the amount of change Da and the amount of change Db coincide with each other or not is checked in ACT 43 in FIG. 7. The coincidence between the amount of change Da and the amount of change Db may not be a complete coincidence. A predetermined range of tolerance may be set in advance, and if the difference between the amount of change Da and the amount of change Db is within the range of tolerance, it may be determined that the amount of change Da and the amount of change Db satisfies the condition for coincidence.

While some embodiments have been described, these embodiments are presented simply as examples and are not intended to limit the scope of the disclosure. These novel embodiments can be carried out in various other forms and can include various omissions, replacements, and modifications without departing from the spirit and scope of the disclosure. These embodiments and the modifications thereof are included in the scope of the disclosure and also included in the scope of the claims and equivalents thereof.

What is claimed is:

1. A commodity registration device comprising:
an input device configured to input information about a commodity; and
a processor configured to:
register sales data of the commodity, based on the information inputted; and
control the input device according to an image captured by a camera of an area where the commodity is placed.

2. The device of claim 1, wherein
the area includes a first area where the commodity associated with the information inputted is placed, and
the processor is configured to set the input device to an input rejection state in response to the information being inputted by the input device, and cancels the input rejection state in response to a detection from the image that the commodity is placed in the first area.

3. The device of claim 2, wherein:
the area further includes a second area where the commodity associated with the information may be placed prior to the information being inputted, and
the processor is configured to set the input device to an input rejection state until the commodity is placed in the second area, and cancels the input rejection state in response to a detection from the image that the commodity is placed in the second area.

4. The device of claim 3, wherein the processor is further configured to:
set the input device to an input waiting state for settlement information in response to a detection from the image that the commodity placed in the second area is removed.

5. The device of claim 4, wherein the processor is further configured to:
activate a first warning in response to a detection from the image that the commodity is placed in the first area after settlement is finished by input of the settlement information.

6. The device of claim 5, wherein the processor is further configured to:
activate a second warning in response to a detection that the commodity is placed in the first area when a second commodity is placed in the second area.

7. The device of claim 3, wherein, the processor is further configured to:
determine whether the same commodity is moved from the second area to the first area, based on a captured image of the second area and a captured image of the first area; and
register the sales data of the commodity on condition that it is determined that the same commodity is moved.

8. The device of claim 3, further comprising:
a first weight scale configured to measure a total weight of the commodity placed in the second area; and
a second weight scale configured to measure a total weight of the commodity placed in the first area, wherein
the processor is configured to register the sales data of the commodity if an amount of change in the total weight measured by the first weight scale and an amount of change in the total weight measured by the second weight scale satisfy a condition for coincidence.

9. A control method for a commodity registration device comprising an input device configured to input information about a commodity, the method comprising:
registering sales data of the commodity, based on the information inputted from the input device; and
controlling the input device according to an image captured by a camera of an area where the commodity is located.

10. The control method of claim 9, further comprising:
setting the input device to an input rejection state in response to the information being inputted by the input device, and
canceling the input rejection state in response to a detection from the image that the commodity is placed in a first area, the first area being a part of the area where the commodity associated with the information inputted may be placed.

11. The control method of claim 10, further comprising:
setting the input device to an input rejection state until the commodity is placed in a second area, and
canceling the input rejection state in response to a detection from the image that the commodity is placed in the second area, the second area being a part of the area where the commodity associated with the information may be placed prior to the information being inputted.

12. The control method of claim 11, further comprising:
setting the input device to an input waiting state for settlement information in response to a detection from the image that the commodity placed in the second area is removed.

13. The control method of claim 12, further comprising:
activating a first warning in response to a detection from the image that the commodity is placed in the first area after settlement is finished by input of the settlement information.

14. The control method of claim 13, further comprising:
activating a second warning in response to a detection that the commodity is placed in the first area when a second commodity is placed in the second area.

15. The control method of claim 11, further comprising:
determining whether the same commodity is moved from the second area to the first area, based on a captured image of the second area and a captured image of the first area; and
registering the sales data of the commodity on condition that it is determined that the same commodity is moved.

16. The control method of claim 11, further comprising:
measuring a total weight of the commodity placed in the second area;
measuring a total weight of the commodity placed in the first area; and
registering the sales data of the commodity in response to determining that an amount of change in the total weight measured in the second area and an amount of change in the total weight measured in the first area satisfy a condition for coincidence.
